(19) United States
(12) Patent Application Publication
(10) Pub. No.: US 2019/0253249 A1
(43) Pub. Date: Aug. 15, 2019

(54) DATA TRANSMISSION METHOD, APPARATUS AND SYSTEM

(71) Applicant: ALIBABA GROUP HOLDING LIMITED, GRAND CAYMAN (KY)

(72) Inventor: Fei MENG, HANGZHOU (CN)

(21) Appl. No.: 16/394,201

(22) Filed: Apr. 25, 2019

Related U.S. Application Data
(63) Continuation of application No. PCT/CN2017/106662, filed on Oct. 18, 2017.

(30) Foreign Application Priority Data
Oct. 26, 2016 (CN) 201610950976.4

(51) Int. Cl. H04L 9/30; H04L 9/08; H04L 9/14; G06Q 20/40

(52) U.S. Cl. CPC H04L 9/3073; H04L 9/0825; H04L 9/14; G06Q 2220/00; H04L 9/0841; G06Q 20/401; H04L 9/085

(57) ABSTRACT

Methods, systems, and apparatus, including computer programs encoded on computer storage media, for data transmission are provided. One of the methods includes: generating, by a computing device, a first asymmetrical key pair comprising a first public key and a first private key, sending, by the computing device, a data request comprising the first public key to a server, and receiving, by the computing device from the server, a ciphertext comprising encrypted data and a second public key. The second public key is associated with a second asymmetrical key pair that further comprises a second private key. The method also includes generating, by the computing device, a shared key based on the first private key and the second public key using a key-agreement algorithm and decrypting, by the computing device, the ciphertext using the shared key.

### CROSS-REFERENCE TO RELATED APPLICATIONS

This application is a continuation application of International Application No. PCT/CN2017/106662, filed on Oct. 18, 2017, which is based on and claims priority to and benefits of Chinese Patent Application No. 201610950976.4 filed with the State Intellectual Property Office (SIPO) of the People's Republic of China on Oct. 26, 2016. The entire contents of the above-identified applications are incorporated herein by reference.

### TECHNICAL FIELD

This application relates to the technical field of network communications, particularly to a data transmission method, apparatus, and system.

### BACKGROUND ART

Nowadays, people are paying increasing attention to data security, particularly data security during transmission. Taking offline payments as an example, a server device may send a strategy for generation of payment codes to a client device, and the client device stores the strategy. When a user needs to use a payment code, the client device may use the strategy to generate a payment code. A merchant scans the payment code by a scanning device. The scanning device transmits information obtained from scanning to the server device for verification. After the information passes the verification, money is deducted. In a process when a server device transmits the strategy to a client device, security of the channel between the client device and the server device needs to be ensured. If the strategy issued by the server device is intercepted by a third-party hacker, serious losses will be incurred by the user of the client device.

In a related art, an identical key may be preset on all client devices and server devices. A server device may use the key to encrypt information to be transmitted and transmit a ciphertext to a client device. The client device uses the key to decrypt the ciphertext. However, as all the client devices and server devices share the same key, if the key of a client device or a server device leaks, all the client devices and server devices will be at a security risk.

In another related art, a client device may generate a pair of asymmetrical keys, save a private key, and upload a public key to a server device. The server device uses the public key to encrypt information that needs to be transmitted and transmits a ciphertext to the client device. The client device uses the private key to decrypt the ciphertext. As the asymmetrical key algorithm uses a different random number during each calculation, a different asymmetrical key pair is generated during each calculation. Therefore, asymmetrical key pairs generated by different clients are different, too, avoiding the problem of a security risk for all client devices and server devices resulting from leakage of the key of a client device or a server device. Meanwhile, as the ciphertext can be decrypted only by the private key to which the public key pair corresponds, even if the public key is intercepted during transmission of the public key, the ciphertext still cannot be decrypted through the public key, thereby ensuring information security. However, an asymmetrical key needs to use a complex encryption algorithm for encryption and a complex decryption algorithm for decryption, so encryption and decryption take a long time.

### SUMMARY

Some embodiments disclosed herein provide a data transmission method, apparatus, and system to solve the problems of information security and prolonged encryption and decryption in current technologies.

In some embodiments, a data transmission method applicable in a client is provided. The method may include generating an asymmetrical key pair comprising a first public key and a first private key, and sending a data request carrying the first public key to a server; receiving a ciphertext and a second public key sent by the server, wherein the second public key is a public key in an asymmetrical key pair obtained by the server, the asymmetrical key pair obtained by the server further comprises a second private key, and the ciphertext is information obtained by encrypting a seed parameter for generating an offline payment code using a shared key; the shared key is a key generated based on the second private key and the first public key using a preset key-agreement algorithm; generating a shared key based on the first private key and the second public key using the key-agreement algorithm, and using the shared key to decrypt the ciphertext to obtain the seed parameter. Here, the shared key generated based on the second private key and the first public key using the preset key-agreement algorithm is identical to the shared key based on the first private key and the second public key generated using the key-agreement algorithm.

According to some embodiments, a data transmission method applicable in a server is provided. The method may include receiving a data request carrying a first public key and sent by a client, wherein the data request is for requesting the server to return a seed parameter for generating an offline payment code, the first public key is a public key in an asymmetrical key pair generated by the client, and the asymmetrical key pair generated by the client further comprises a first private key; obtaining an asymmetrical key pair comprising a second public key and a second private key, and generating a shared key based on the second private key and the first public key using a preset key-agreement algorithm; using the shared key to encrypt a seed parameter to which the data request corresponds, and sending a ciphertext obtained from encryption and the second public key to the client so that the client generates a shared key based on the first private key and the second public key using the key-agreement algorithm and uses the shared key to decrypt the ciphertext to obtain the seed parameter. Here, the shared key generated based on the second private key and the first public key using the preset key-agreement algorithm is identical to the shared key generated based on the first private key and the second public key using the key-agreement algorithm.

In other embodiments, a data transmission method is provided. According to the method, a data requester terminal may generate an asymmetrical key pair comprising a first public key and a first private key and send a data request carrying the first public key to a data provider terminal. The data provider terminal may obtain an asymmetrical key pair comprising a second public key and a second private key and generate a shared key based on the second private key and the first public key using a preset key-agreement algorithm. The data provider terminal may use the shared key to encrypt target data to which the data request corresponds and send a ciphertext obtained from encryption and the second public key to the data requester terminal. The data requester terminal may generate a shared key based on the first private key and the second public key using the key-agreement algorithm and use the shared key to decrypt the ciphertext to obtain the target data. Here, the shared key generated based on the second private key and the first public key using the preset key-agreement algorithm is identical to the shared key generated based on the first private key and the second public key using the key-agreement algorithm.

In some embodiments, a data transmission apparatus is provided. The apparatus may include a key generation module configured to generate an asymmetrical key pair comprising a first public key and a first private key; a request sending module configured to send a data request carrying the first public key to a server; an information receiving module configured to receive a ciphertext and a second public key sent by the server, wherein the second public key is a public key in an asymmetrical key pair obtained by the server, the asymmetrical key pair obtained by the server further comprises a second private key, and the ciphertext is information obtained by encrypting a seed parameter for generating an offline payment code using a shared key; the shared key is a key generated based on the second private key and the first public key using a preset key-agreement algorithm; a shared key generation module configured to generate a shared key based on the first private key and the second public key using the key-agreement algorithm; and an information decryption module configured to use the shared key to decrypt the ciphertext to obtain the seed parameter. Here, the shared key generated based on the second private key and the first public key using the preset key-agreement algorithm is identical to the shared key generated based on the first private key and the second public key using the key-agreement algorithm.

According to some embodiments, a data transmission apparatus is provided. The apparatus may include a request receiving module configured to receive a data request carrying a first public key and sent by a client, wherein the data request is for requesting a server to return a seed parameter for generating an offline payment code, the first public key is a public key in an asymmetrical key pair generated by the client, and the asymmetrical key pair generated by the client further comprises a first private key; a key obtaining module configured to obtain an asymmetrical key pair comprising a second public key and a second private key; a shared key generation module configured to generate a shared key based on the second private key and the first public key using a preset key-agreement algorithm; an information encryption module configured to use the shared key to encrypt a seed parameter to which the data request corresponds; and an information sending module configured to send a ciphertext obtained from encryption and the second public key to the client so that the client generates a shared key based on the first private key and the second public key using the key-agreement algorithm and uses the shared key to decrypt the ciphertext to obtain the seed parameter. Here, the shared key generated based on the second private key and the first public key using the preset key-agreement algorithm is identical to the shared key generated based on the first private key and the second public key using the key-agreement algorithm.

In other embodiments, a data transmission system is provided. The system may include a data requester device and a data provider device. The data requester device may generate an asymmetrical key pair comprising a first public key and a first private key and send a data request carrying the first public key to a data provider device. The data provider device may obtain an asymmetrical key pair comprising a second public key and a second private key and generate a shared key based on the second private key and the first public key using a preset key-agreement algorithm. The data provider device may use the shared key to encrypt target data to which the data request corresponds and send a ciphertext obtained from encryption and the second public key to the data requester device. The data requester device may generate a shared key based on the first private key and the second public key using the key-agreement algorithm and use the shared key to decrypt the ciphertext to obtain the target data. Here, the shared key generated based on the second private key and the first public key using the preset key-agreement algorithm is identical to the shared key generated based on the first private key and the second public key using the key-agreement algorithm.

In some embodiments, a data transmission method is provided. According to the method, a data requester terminal may generate a first symmetric key and send a data request carrying the first symmetric key to a data provider terminal. The data provider terminal may obtain a second symmetric key and generate a shared key based on the first symmetric key and the second symmetric key using a preset key-agreement algorithm, the second symmetric key being different from the first symmetric key. The data provider terminal may use the shared key to encrypt target data to which the data request corresponds and send a ciphertext obtained from encryption and the second symmetric key to the data requester terminal. The data requester terminal may generate a shared key based on the first symmetric key and the second symmetric key using the key-agreement algorithm and use the shared key to decrypt the ciphertext to obtain the target data.

In other embodiments, a data transmission system is provided. The system may include a data requester device and a data provider device. The data requester device may generate a first symmetric key and send a data request carrying the first symmetric key to a data provider device. The data provider device may obtain a second symmetric key and generate a shared key based on the first symmetric key and the second symmetric key using a preset key-agreement algorithm, the second symmetric key being different from the first symmetric key. The data provider device may use the shared key to encrypt target data to which the data request corresponds and send a ciphertext obtained from encryption and the second symmetric key to the data requester device. The data requester device may generate a shared key based on the first symmetric key and the second symmetric key using the key-agreement algorithm and use the shared key to decrypt the ciphertext to obtain the target data.

In some embodiments, the specification provides a data-transmission method. The method may include generating, by a computing device, a first asymmetrical key pair comprising a first public key and a first private key, sending, by the computing device, a data request comprising the first public key to a server, and receiving, by the computing device from the server, a ciphertext comprising encrypted data and a second public key. The second public key may be associated with a second asymmetrical key pair that further comprises a second private key. The method may also include generating, by the computing device, a shared key based on the first private key and the second public key using a key-agreement algorithm and decrypting, by the computing device, the ciphertext using the shared key.

According to some embodiments, the data may comprise a seed parameter for generating an offline payment code.

In the embodiments of the specification, the shared key may be identical to a key generated based on the second private key and the first public key using the key-agreement algorithm.

In some embodiments, the sending a data request comprising the first public key to a server may comprise obtaining first signature information by signing the first public key using a private key in a client certificate and including the first signature information in the data request.

According to some embodiments, the key-agreement algorithm may be a Diffie-Hellman key exchange algorithm based on elliptic curve cryptosystems.

In some embodiments, the computing device may be a wearable device.

According to some embodiments, the wearable device may comprise a smart bracelet.

In some embodiments, the specification provides a data-transmission system. The system may include a processor and a non-transitory computer-readable storage medium storing instructions executable by the processor to cause the system to perform operations. The operations may include generating a first asymmetrical key pair comprising a first public key and a first private key, sending a data request comprising the first public key to a server, receiving a ciphertext comprising encrypted data and a second public key, where the second public key is associated with a second asymmetrical key pair that further comprises a second private key, generating a shared key based on the first private key and the second public key using a key-agreement algorithm, and decrypting the ciphertext using the shared key.

According to some embodiments, the specification provides a non-transitory computer-readable storage medium for data transmission. The medium may be configured with instructions executable by one or more processors to cause the one or more processors to perform operations. The operations may include generating a first asymmetrical key pair comprising a first public key and a first private key, sending a data request comprising the first public key to a server, receiving a ciphertext comprising encrypted data and a second public key, where the second public key is associated with a second asymmetrical key pair that further comprises a second private key, generating a shared key based on the first private key and the second public key using a key-agreement algorithm, and decrypting the ciphertext using the shared key.

During application of the data transmission method, apparatus, and system provided in embodiments of the specification, an asymmetrical key pair comprising a first public key and a first private key may be generated through a data requester terminal, a data request carrying the first public key is sent to a data provider terminal, an asymmetrical key pair comprising a second public key and a second private key is obtained through a data provider terminal, a shared key is generated based on the second private key and the first public key using a preset key-agreement algorithm, then the shared key is used to encrypt target data to which the data request corresponds, and lastly a ciphertext obtained from encryption and the second public key are transmitted to the data requester terminal, and the data requester terminal generates a shared key based on the first private key and the second public key using the same key-agreement algorithm. As the shared key generated based on the second private key and the first public key using the preset key-agreement algorithm is identical to the shared key generated based on the first private key and the second public key using the key-agreement algorithm, the data provider terminal may use the shared key for encryption, and the data requester terminal may use the shared key for decryption. As the key for encryption of target data and the key for decryption of target data are identical, symmetric encryption and decryption algorithms may be used to encrypt and decrypt data. As a symmetric encryption algorithm typically conducts encryption by such means as shift cipher, while an asymmetrical encryption algorithm conducts encryption by such methods as finding large prime numbers, the encryption process of a symmetric encryption algorithm may generally be simpler than the encryption process of an asymmetrical encryption algorithm. Some embodiments may avoid the defect of long encryption and decryption times resulting from complex asymmetrical encryption and decryption algorithms and improve encryption and decryption efficiency. Further, as the complete key is not exposed through the entire transmission process, relevant data cannot be decrypted even if a public key is hijacked by a hacker, thereby ensuring data security throughout the entire transmission process.

During application of the data transmission method, apparatus, and system provided in embodiments of the specification, a first symmetric key may be obtained through a data requester terminal, a data request carrying the first symmetric key is sent to a data provider terminal, a second symmetric key is obtained through a data provider terminal, a shared key is generated based on the first symmetric key and the second symmetric key using a preset key-agreement algorithm, the shared key is used to encrypt target data to which the data request corresponds, and lastly a ciphertext obtained from encryption and the second symmetric key are transmitted to the data requester terminal, and the data requester terminal uses the same key-agreement algorithm to generate a shared key based on the first symmetric key and the second symmetric key. As the data provider terminal and the data requester terminal use an identical key-agreement algorithm, the shared key generated by the data provider terminal and that generated by data requester terminal are identical, and the data requester terminal may decrypt the ciphertext through the generated shared key, thereby obtaining the target data. As the shared key is different from the first symmetric key and the second symmetric key, even if a hacker has hijacked the symmetric key, the hacker will not know what key-agreement algorithm the terminals have used, so the hacker is unable to decrypt the ciphertext, thereby ensuring data security throughout the entire transmission process. Further, as the key for encryption of target data and the key for decryption of target data are identical, symmetric key encryption and decryption algorithms are used to encrypt and decrypt data to avoid long encryption and decryption times resulting from complex asymmetrical encryption and decryption algorithms, thereby improving encryption and decryption efficiency.

It should be understood that the foregoing general description and subsequent detailed description are exemplary and explanatory only and cannot limit the specification.

### BRIEF DESCRIPTION OF THE DRAWINGS

The accompanying drawings here are included into and constitute a part of the Description, show embodiments conforming to the specification, and are used together with the Description to explain the principles of the specification.

FIG. 1A is a schematic diagram of an application scenario of data transmission.

FIG. 1B is a flow chart of an embodiment of a data transmission method.

FIG. 2 is a flow chart of another embodiment of a data transmission method.

FIG. 3 is a flow chart of another embodiment of a data transmission method.

FIG. 4 is a block diagram of an embodiment of a data transmission system.

FIG. 5 is a block diagram of an embodiment of a data transmission apparatus.

FIG. 6 is a block diagram of another embodiment of a data transmission apparatus.

FIG. 7 is a flow chart of another embodiment of a data transmission method.

FIG. 8 is a block diagram of another embodiment of a data transmission system.

### DETAILED DESCRIPTION

Here, embodiments will be described in detail, with examples shown in the accompanying drawings. When the description below involves the accompanying drawings, unless otherwise indicated, the same numeral in different accompanying drawings stands for the same or similar element. The implementation manners described in the following embodiments do not represent all the implementation manners consistent with the specification. Conversely, they are only examples of the apparatus and method described in detail in the attached claims and consistent with some aspects of the specification.

The terms used in the specification are only for the purpose of describing some embodiments and not intended to limit the specification. The singular forms “one”, “the”, and “this” used in the specification and in the attached claims also are intended to cover plural forms unless their meanings are otherwise clearly indicated in the context. It should also be understood that the term “and/or” used in the text refers to any or all possible combinations containing one or a plurality of the associated listed items.

It should be understood that although the specification may use terms such as first, second, and third to describe various kinds of information, the information should not be limited to these terms. These terms are only intended to differentiate information of the same type. For example, without departing from the scope of the specification, first information may also be referred to as second information, and similarly, second information may also be referred to as first information. Subject to the context, the term “if” used here may be interpreted as “at the time of . . . ”, “when . . . ”, or “in response to a determination.”

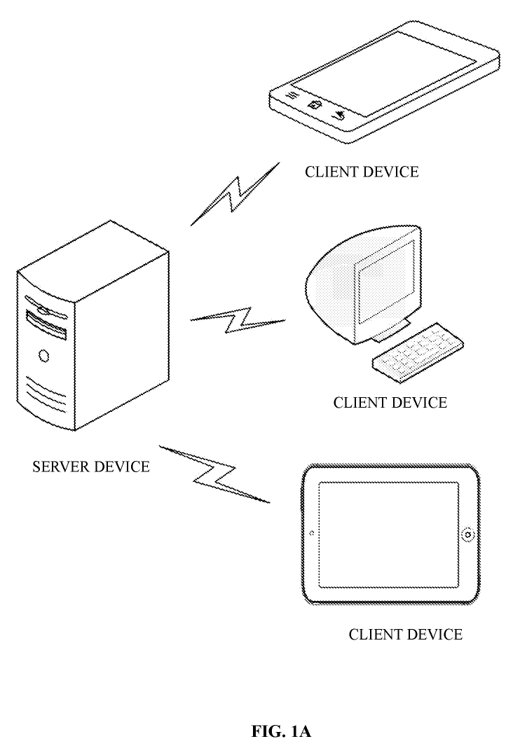

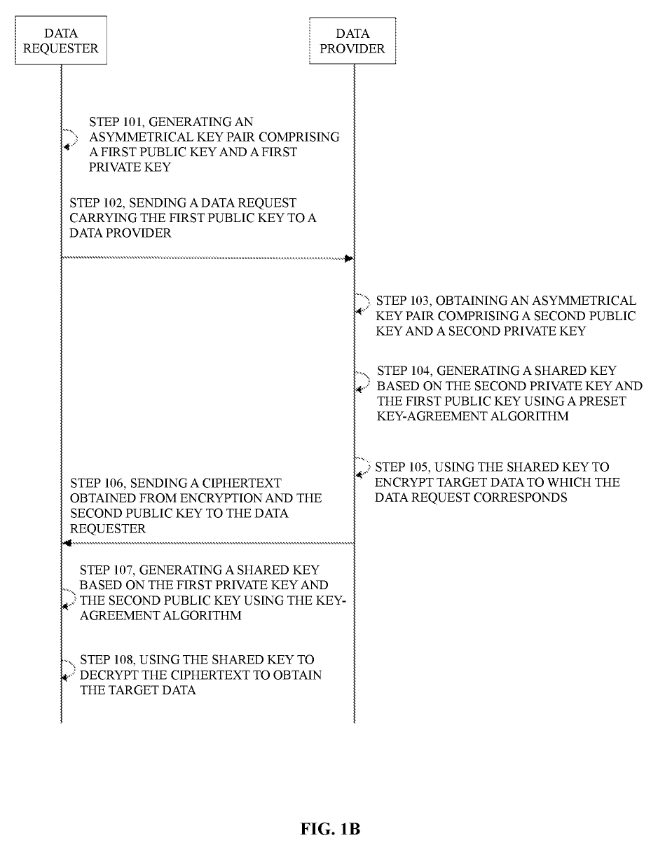

FIG. 1A is a schematic diagram of an application scenario of data transmission. In this schematic diagram, data transmission may be conducted between different client devices and server devices. For example, a client device sends a data request to a server device, and the server device returns corresponding target data according to the data request. In the transmission process, hackers might intercept the target data that is being transmitted, thereby causing losses to users.

In order to avoid the information security problems and the problem of encryption and decryption taking a long time, the specification provides a data transmission method, as shown in FIG. 1B. FIG. 1B is a flow chart of an embodiment of a data transmission method. This method may comprise the following step 101˜step 108:

In step 101, a data requester terminal generates an asymmetrical key pair comprising a first public key and a first private key.

In step 102, the data requester terminal sends a data request carrying the first public key to a data provider terminal.

In step 103, the data provider terminal obtains an asymmetrical key pair comprising a second public key and a second private key.

In step 104, the data provider terminal generates a shared key based on the second private key and the first public key using a preset key-agreement algorithm.

In step 105, the data provider terminal uses the shared key to encrypt target data to which the data request corresponds.

In step 106, the data provider terminal sends a ciphertext obtained from encryption and the second public key to the data requester terminal.

In step 107, the data requester terminal generates a shared key based on the first private key and the second public key using the key-agreement algorithm.

In step 108, the data requester terminal uses the shared key to decrypt the ciphertext to obtain the target data.

Here, the data requester terminal is the terminal requesting data, and the data provider terminal is the terminal providing data. In an example, the data requester terminal may be a client, the data provider terminal may be a server, and the client requests the server to return target data. Taking target data that is a seed parameter for generating an offline payment code as an example, the data request may be a request for activating offline payment, the data requester terminal is a client, and the data provider terminal is a server. The client sends a request for activating offline payment to the server, and the server returns a seed parameter to the client according to the request. In another example, the server may also request data from the client, and in this way, the data requester terminal may be a server and the data provider terminal may be a client.

In some embodiments, an asymmetrical key pair comprising a first public key and a first private key may be generated through a data requester terminal, a data request carrying the first public key is sent to a data provider terminal, an asymmetrical key pair comprising a second public key and a second private key is obtained through the data provider terminal, a shared key is generated based on the second private key and the first public key using a preset key-agreement algorithm, then the shared key is used to encrypt target data to which the data request corresponds, and lastly a ciphertext obtained from encryption and the second public key are transmitted to the data requester terminal, and the data requester terminal generates a shared key based on the first private key and the second public key using the same key-agreement algorithm. As the shared key generated based on the second private key and the first public key using the preset key-agreement algorithm is identical to the shared key generated based on the first private key and the second public key using the key-agreement algorithm, the data provider terminal may use the shared key for encryption, and the data requester terminal may use the shared key for decryption. As the key for encryption of target data and the key for decryption of target data are identical, symmetric encryption and decryption algorithms may be used to encrypt and decrypt data. As a symmetric encryption algorithm typically conducts encryption by such means as shift cipher, while an asymmetrical encryption algorithm conducts encryption by such method as finding large prime numbers, the encryption process of a symmetric encryption algorithm may be simpler than the encryption process of an asymmetrical encryption algorithm. Therefore, this embodiment may avoid the defect of long encryption and decryption times resulting from complex asymmetrical encryption and decryption algorithms and improve encryption and decryption efficiency. As a different random number is used each time, a different asymmetrical key pair is generated each time. Therefore, asymmetrical key pairs generated by different clients are different, too, avoiding the problem of a security risk for all client devices and server devices resulting from leakage of the key of a client device or a server device. Further, as the complete key is not exposed throughout the entire transmission process, it is meaningless even if the public key is hijacked by a hacker, thereby ensuring data security throughout the entire transmission process.

The asymmetrical key pair comprising a first public key and a first private key may be generated at various time points. For example, an asymmetrical key pair may be generated prior to each data request transmission. As another example, an asymmetrical key pair may be generated at a time other than right before a data request is sent, such as when other conditions are met, so that a previously generated asymmetrical key pair can be obtained when a data request is to be sent. For example, an asymmetrical key pair may be generated at set intervals, and each newly generated asymmetrical key pair replaces the previously generated asymmetrical key pair.

In an example, a first public key and a first private key may be an asymmetrical key pair generated using a key generation algorithm. Before a data request is sent, the data requester terminal uses the key generation algorithm each time to generate an asymmetrical key pair comprising a first public key and a first private key. As the asymmetrical key pair generated by the asymmetrical key algorithm is different each time under normal conditions, this may avoid the problem of leakage of a key pair stored in a fixed manner resulting in all subsequent information encrypted using the key pair being insecure.

After a data requester terminal obtains a first public key and a first private key, the data requester terminal may send a data request carrying the first public key to a data provider terminal. Here, the data request is a request for target data.

In an example, the data requester terminal may directly include a first public key in a data request, thereby raising the speed of sending a data request.

In another example, sending a data request carrying the first public key to a data provider terminal comprises the data requester terminal using a private key in a requester certificate to sign the first public key to obtain first signature information and sending a data request carrying the first public key and the first signature information to a data provider terminal. The requester certificate is a certificate issued by a designated institution to the data requester terminal.

The method further comprises the following steps: the data provider terminal verifies the first signature information based on a public key in the requester certificate and the first public key. If the verification is successful, the data provider terminal will send the ciphertext and the second public key to the data requester terminal.

Here, the designated institution typically refers to an institution that is authoritative and can issue certificates. A certificate issued by the designated institution to a data requester terminal comprises at least a private key and a public key. In other words, a requester certificate comprises a private key and a public key.

As an example signing method, a data requester terminal may use a hash algorithm to perform hash operations on a first public key to obtain a first information abstract, use a private key in a requester certificate to encrypt the first information abstract to obtain first signature information, then generate a data request carrying the first public key and the first signature information based on the first signature information, and send the data request to a data provider terminal.

After the data provider terminal receives the data request, the data provider terminal may verify the first signature information based on a public key in the requester certificate and the first public key. If the verification is successful, the ciphertext and the second public key will be sent to the data provider terminal.

Here, the data provider terminal may obtain the public key in the requester certificate by the following method: the data requester terminal broadcasts it to the data provider terminal in advance, or the data requester terminal sends it to the data provider terminal while sending a data request.

As an example verification method, a data provider terminal may use a hash algorithm to perform hash operations on a received first public key to obtain a second information abstract, use a public key in a requester certificate to decrypt first signature information to obtain a first information abstract, and verify whether the first information abstract is consistent with the second information abstract. If consistent, it means the verification is successful. The data provider terminal can execute the operation of sending a ciphertext and a second public key to the data requester terminal only after the verification is successful.

In some embodiments, signing a first public key and successfully verifying the first signature information may guarantee the first public key is not tampered with, and meanwhile a requester certificate ensures the data requester terminal is a safe terminal authenticated by an authoritative institution, thereby ensuring the security of the negotiation process of a shared key.

After a data provider terminal receives a data request, the data provider terminal may obtain an asymmetrical key pair comprising a second public key and a second private key. Here, the second public key and the second private key may be a key pair generated using the key generation algorithm. In some embodiments, the asymmetrical key pair comprising a first public key and a first private key and the asymmetrical key pair comprising a second public key and a second private key may be generated by the same key generation algorithm. As the key generation algorithm uses a different random number during each calculation, asymmetrical key pairs generated during calculation at different times would almost always be different. Therefore, the asymmetrical key pair generated by the data requester terminal is different from the asymmetrical key pair generated by the data provider terminal under normal circumstances.

The asymmetrical key pair comprising a second public key and a second private key may be generated at various time points. For example, an asymmetrical key pair may be generated each time a data request is received. As another example, an asymmetrical key pair may be generated not when a data request is received but when other conditions are met so that a previously generated asymmetrical key pair can be obtained when a data request is received. For example, an asymmetrical key pair may be generated at set intervals, and each newly generated asymmetrical key pair replaces the previously generated asymmetrical key pair.

In an example, when a data request is received, a data provider terminal uses a key generation algorithm each time to generate an asymmetrical key pair comprising a second public key and a second private key. As the asymmetrical key pair generated by the asymmetrical key algorithm is different each time under normal conditions, this may avoid the problem of leakage of a key pair stored in a fixed manner resulting in all subsequent information encrypted using the key pair being insecure.

After a data provider terminal obtains an asymmetrical key pair comprising a second public key and a second private key, the data provider terminal may generate a shared key based on the second private key and the first public key using a preset key-agreement algorithm. Subsequently, a data requester terminal will generate a shared key based on a first private key and the second public key using the key-agreement algorithm.

A key-agreement algorithm, also known as a key exchange algorithm, may be an ECDH algorithm, for example. Here, ECDH is a DH (Diffie-Hellman) key exchange algorithm based on ECC (Elliptic Curve Cryptosystems). Therefore, the two parties may negotiate to obtain a common key without sharing any secret information.

In this embodiment, the shared key generated based on the second private key and the first public key using the preset key-agreement algorithm is identical to the shared key generated based on the first private key and the second public key using the key-agreement algorithm. In some embodiments, the key-agreement algorithms used by a data provider terminal and a data requester terminal are identical, the key generation algorithms used by the data provider terminal and the data requester terminal are also identical, and the key-agreement algorithm and the key generation algorithm meet the following condition: for any two asymmetrical key pairs generated using the key generation algorithm, when a public key of any of the two asymmetrical key pairs and a private key of the other asymmetrical key pair are selected, negotiation results obtained using the key-agreement algorithm are identical.

Given that a first public key typically is not equal to a second public key and a first private key typically is not equal to a second private key, that it is impossible to deduce a first private key from a first public key or deduce a second private key from a second public key, and that a shared key negotiated from a first private key and a second public key is identical to a shared key negotiated from a second private key and a first public key, the complete key is not exposed at any time during the entire transmission process. In this manner, data security is ensured throughout the whole transmission process. Further, as the key for encryption of target data and the key for decryption of target data are identical, symmetric key encryption and decryption algorithms are used to encrypt and decrypt data to avoid long encryption and decryption times resulting from complex asymmetrical encryption and decryption algorithms, thereby improving encryption and decryption efficiency.

After a data provider terminal generates a shared key, the data provider terminal may use the shared key to encrypt target data to which the data request corresponds and send a ciphertext obtained from encryption and the second public key to the data requester terminal.

In an example, a data provider terminal may directly send a second public key to a data requester terminal to improve sending efficiency.

In another example, the method further comprises: the data provider terminal using a private key in a provider certificate to sign the second public key to obtain second signature information. The provider certificate is a certificate issued by a designated institution to the data provider terminal.

When the data provider terminal sends a ciphertext obtained from encryption and the second public key to the data requester terminal, the data provider terminal will further send the second signature information to the data requester terminal.

The data requester terminal verifies the second signature information based on a public key in the provider certificate and the second public key. If the verification is successful, the data requester terminal will decrypt the ciphertext.

Here, the designated institution may be an institution that can issue certificates. A certificate issued by the designated institution to a data provider terminal comprises at least a private key and a public key. In other words, a provider certificate comprises a private key and a public key.

As an example signing method, a data provider terminal may use a hash algorithm to perform hash operations on a second public key to obtain a third information abstract, use a private key in a provider certificate to encrypt the third information abstract to obtain second signature information, and then send the ciphertext, second public key, and second signature information to the data requester terminal.

The data requester terminal verifies the second signature information based on a public key in the provider certificate and the second public key. If the verification is successful, the data requester terminal will decrypt the ciphertext.

Here, the data requester terminal may obtain the public key in the provider certificate by the following method: the data provider terminal broadcasts it to the data requester terminal in advance, or the data provider terminal sends it to the data requester terminal while sending a ciphertext and a second public key.

As an example verification method, a data requester terminal may use a hash algorithm to perform hash operations on a received second public key to obtain a fourth information abstract, use a public key in a provider certificate to decrypt the second signature information to obtain a third information abstract, and verify whether the third information abstract is consistent with the fourth information abstract. If consistent, it means the verification is successful. The data requester terminal can execute the operation of decrypting a ciphertext only after the verification is successful.

In some embodiments, signing a second public key and successfully verifying the second signature information may guarantee the second public key is not tampered with, and meanwhile a provider certificate ensures the data provider terminal is a safe terminal authenticated by an authoritative institution, thereby ensuring the security of the negotiation process of a shared key.

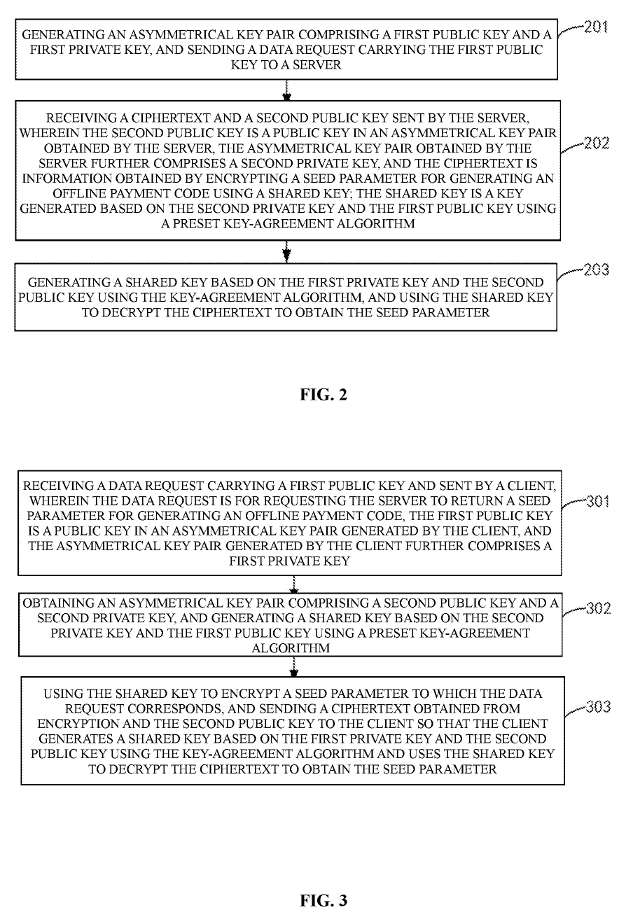

FIG. 2 is a flow chart of another embodiment of a data transmission method. The embodiment applies the data transmission method to transmit a seed parameter. The method is applicable in a client and may comprise the following step 201˜step 203:

In step 201, generating an asymmetrical key pair comprising a first public key and a first private key, and sending a data request carrying the first public key to a server.

Here, an asymmetrical key pair comprising a first public key and a first private key may be generated at various time points. For example, an asymmetrical key pair may be generated prior to each data request transmission. As another example, an asymmetrical key pair may be generated at a time other than right before a data request is sent but when other conditions are met, so that a previously generated asymmetrical key pair can be obtained when a data request is sent. For example, an asymmetrical key pair may be generated at set intervals, and each newly generated asymmetrical key pair replaces the previously generated asymmetrical key pair.

In an example, a first public key and a first private key may be an asymmetrical key pair generated using a key generation algorithm. Before a data request is sent, the client uses the key generation algorithm each time to generate an asymmetrical key pair comprising a first public key and a first private key. As the asymmetrical key pair generated by the asymmetrical key algorithm is different each time under normal conditions, this may avoid the problem of leakage of a key pair stored in a fixed manner resulting in all subsequent information encrypted using the key pair being insecure.

After a first public key and a first private key are obtained, a data request carrying the first public key may be sent to a server. Here, the data request is for requesting the server to return a seed parameter for generating an offline payment code.

In an example, a first public key may be directly carried in a data request, thereby raising the speed of sending a data request.

In another example, sending a data request carrying the first public key to a server comprises: using a private key in a client certificate to sign the first public key to obtain first signature information, wherein the client certificate is a certificate issued by a designated institution to the client; and sending a data request carrying the first public key and the first signature information to a server so that the server uses a public key in the client certificate and the first public key to verify the first signature information, and sends the ciphertext and the second public key to the client if verification is successful.

Here, the designated institution may be an institution that can issue certificates. A certificate issued by the designated institution to a client comprises at least a private key and a public key. In other words, a client certificate comprises a private key and a public key. The server may obtain the public key in the client certificate by the following method: the client broadcasts it to the server in advance, or the client sends it to the server while sending a data request.

The present embodiment may use a private key in a client certificate to sign a first public key. For example, the client may use a hash algorithm to perform hash operations on the first public key to obtain a first information abstract, use a private key in the client certificate to encrypt the first information abstract to obtain first signature information, and then send a data request carrying the first public key and the first signature information to a data provider terminal.

In some embodiments, signing a first public key facilitates a server to verify first signature information, successful verification may guarantee the first public key is not tampered with, and meanwhile a client certificate ensures the client is a safe terminal authenticated by an authoritative institution, thereby ensuring the security of the negotiation process of a shared key.

In step 202, receiving a ciphertext and a second public key sent by the server, wherein the second public key is a public key in an asymmetrical key pair obtained by the server, the asymmetrical key pair obtained by the server further comprises a second private key, and the ciphertext is information obtained by encrypting a seed parameter for generating an offline payment code using a shared key; the shared key is a key generated based on the second private key and the first public key using a preset key-agreement algorithm. In step 203, generating a shared key based on the first private key and the second public key using the key-agreement algorithm, and using the shared key to decrypt the ciphertext and obtain the seed parameter.

Here, a key-agreement algorithm, also known as a key exchange algorithm, may be an ECDH algorithm, for example, wherein ECDH is a DH (Diffie-Hellman) key exchange algorithm based on ECC (Elliptic Curve Cryptosystems). Therefore, the two parties may negotiate a common key without sharing any secret information.

In this embodiment, the shared key generated based on the second private key and the first public key using the preset key-agreement algorithm is identical to the shared key generated based on the first private key and the second public key using the key-agreement algorithm. In some embodiments, the key-agreement algorithms used by a data provider terminal and a data requester terminal are identical, the key generation algorithms used by the data provider terminal and the data requester terminal are also identical, and the key-agreement algorithm and the key generation algorithm meet the following condition: for any two asymmetrical key pairs generated using the key generation algorithm, when a public key of any of the two asymmetrical key pairs and a private key of the other asymmetrical key pair are selected, negotiation results obtained using the key-agreement algorithm are identical.

Given that a first public key typically is not equal to a second public key and a first private key typically is not equal to a second private key, that it is impossible to deduce a first private key from a first public key or deduce a second private key from a second public key, and that the shared key negotiated from a first private key and a second public key is identical to the shared key negotiated from a second private key and a first public key, the complete key is not exposed at any time during the entire transmission process. In this manner, data security is ensured throughout the whole transmission process. Further, as a key for encryption of a seed parameter and a key for decryption of a seed parameter are identical, symmetric key encryption and decryption algorithms are used to encrypt and decrypt a seed parameter to avoid long encryption and decryption times resulting from complex asymmetrical encryption and decryption algorithms, thereby improving encryption and decryption efficiency.

In some embodiments, a client may be in an electronic device (e.g., in a wearable device). A wearable device may have less processing capabilities compared to certain other devices. When the solution of some embodiments is used in a wearable device, symmetric encryption is used. Because symmetric encryption and decryption algorithms are not very demanding on resources (as compared with asymmetric encryption and decryption), while ensuring transmission security, this solution may greatly improve performance on a wearable device and improve the efficiency of the whole transmission process. Further, a wearable device may comprise a smart bracelet. Implementing the embodiment through a smart bracelet may not only guarantee the transmission security of a seed parameter but also ensure the efficiency of the whole transmission process.

In an example, the method in the embodiment may be executed through a secure element (SE), thereby enabling generation of an asymmetrical key, generation of a shared key, and decryption of a ciphertext to be executed in the SE. Further, a seed parameter may also be stored in an SE. As the SE has an anti-cracking function, the SE may provide a seed parameter with a very high security level.

Further, a seed parameter may be stored in an SE, and meanwhile access authority of the SE may be set, too, with payment code generation being controlled through fingerprint recognition, pulse recognition, face recognition, or other verification methods, thereby providing the whole payment code with a very high security level.

FIG. 3 is a flow chart of another embodiment of a data transmission method. The embodiment uses the data transmission method to transmit a seed parameter. When the method is used in a server, it may comprise the following step 301˜step 303:

In step 301, receiving a data request carrying a first public key and sent by a client, wherein the data request is for requesting the server to return a seed parameter for generating an offline payment code, the first public key is a public key in an asymmetrical key pair generated by the client, and the asymmetrical key pair generated by the client further comprises a first private key.

Here, when a data request is received, if the data request only carries a first public key, step 302 may be executed directly; if the data request carries a first public key and first signature information, the first signature information is verified based on a public key in a client certificate and the first public key, and step 302 is executed only after the verification is successful.

Here, the server may obtain the public key in the client certificate by the following method: the client broadcasts it to the server in advance, or the client sends it to the server while sending a data request.

As an example verification method, a server may use a hash algorithm to perform hash operations on a received first public key to obtain a second information abstract, use a public key in a client certificate to decrypt the first signature information to obtain a first information abstract, and verify whether the first information abstract is consistent with the second information abstract. If consistent, it means the verification is successful. The server subsequently will return a ciphertext and a second key to the client.

In step 302, obtaining an asymmetrical key pair comprising a second public key and a second private key, and generating a shared key based on the second private key and the first public key using a preset key-agreement algorithm.

In step 303, using the shared key to encrypt a seed parameter to which the data request corresponds, and sending a ciphertext obtained from encryption and the second public key to the client so that the client generates a shared key based on the first private key and the second public key using the key-agreement algorithm and uses the shared key to decrypt the ciphertext and obtain the seed parameter.

The asymmetrical key pair comprising a second public key and a second private key may be generated at various time points. For example, an asymmetrical key pair may be generated each time a data request is received. As another example, an asymmetrical key pair may be generated at a time other than when a data request is received but when other conditions are met so that a previously generated asymmetrical key pair can be obtained when a data request is received. For example, an asymmetrical key pair may be generated at set intervals, and each newly generated asymmetrical key pair replaces the previously generated asymmetrical key pair.

In an example, the second public key and the second private key may be a key pair generated using the key generation algorithm. For example, when a data request is received, a server uses the key generation algorithm each time to generate an asymmetrical key pair comprising a second public key and a second private key. As the asymmetrical key pair generated by the asymmetrical key algorithm is different each time under normal conditions, this may avoid the problem of leakage of a key pair stored in a fixed manner resulting in all subsequent information encrypted using the key pair being insecure.

In some embodiments, the asymmetrical key pair comprising a first public key and a first private key and the asymmetrical key pair comprising a second public key and a second private key may be generated by the same key generation algorithm. As the key generation algorithm uses a different random number during each calculation, the asymmetrical key pairs generated during calculation at different times would seem different. Therefore, the asymmetrical key pair generated by the client is different from the asymmetrical key pair generated by the server under normal circumstances.

After a server obtains a second public key and a second private key, the server may generate a shared key based on the second private key and the first public key using a preset key-agreement algorithm.

A key-agreement algorithm, also known as a key exchange algorithm, may be an ECDH algorithm, for example, wherein ECDH is a DH (Diffie-Hellman) key exchange algorithm based on ECC (Elliptic Curve Cryptosystems). Therefore, the two parties may negotiate a common key without sharing any secret information.

In this embodiment, the shared key generated based on the second private key and the first public key using the preset key-agreement algorithm is identical to the shared key generated based on the first private key and the second public key using the key-agreement algorithm. In some embodiments, the key-agreement algorithms used by a data provider terminal and a data requester terminal may be identical, the key generation algorithms used by the data provider terminal and the data requester terminal may also be identical, and the key-agreement algorithm and the key generation algorithm may meet the following condition: for any two asymmetrical key pairs generated using the key generation algorithm, when a public key of any of the two asymmetrical key pairs and a private key of the other asymmetrical key pair are selected, negotiation results obtained using the key-agreement algorithm are identical.

After a server obtains a shared key, the server may use the shared key to encrypt a seed parameter to which the data request corresponds and send a ciphertext obtained from encryption and the second public key to a client. The seed parameter is a seed parameter for generating an offline payment code. After the server receives a data request, the server may obtain a seed parameter according to the data request. The seed parameters to which clients correspond may be the same or different, subject to actual requirements.

As for the sending of a second public key, in one example, the second public key may be directly sent to a client to raise sending speed.

In another example, the method further comprises: using a private key in a server certificate to sign the second public key to obtain second signature information. The server certificate is a certificate issued by a designated institution to the server.

While sending a ciphertext obtained from encryption and the second public key to the client, the server may also send the second signature information to the client, so that the client verifies the second signature information based on a public key in the server certificate and the second public key. If the verification is successful, the client will decrypt the ciphertext.

Here, the designated institution may be an institution that can issue certificates. A certificate issued by the designated institution to a server comprises at least a private key and a public key. In other words, a server certificate comprises a private key and a public key. The client may obtain the public key in the server certificate by the following method: the server broadcasts it to the client in advance, or the server sends it to the client while sending a ciphertext and a second public key.

As an example signing method, a server may use a hash algorithm to perform hash operations on a second public key to obtain a third information abstract, use a private key in a server certificate to encrypt the third information abstract to obtain second signature information, and then send the ciphertext, the second public key, and the second signature information to the client.

The client may verify the second signature information based on the public key in the server certificate and the second public key. If successful, the client will decrypt the ciphertext.

As an example verification method, a client may use a hash algorithm to perform hash operations on a second public key to obtain a fourth information abstract, use a public key in a server certificate to decrypt second signature information to obtain a third information abstract, and verify whether the third information abstract is consistent with the fourth information abstract. If consistent, it means the verification is successful. The client can execute the operation of decrypting a ciphertext only after successful verification.

In some embodiments, signing a second public key and successfully verifying second signature information may guarantee the second public key is not tampered with, and meanwhile a server certificate ensures the server is a safe end authenticated by an authoritative institution, thereby ensuring the security of the negotiation process of a shared key.

Corresponding to an embodiment of a data transmission method provided by the specification, the specification further provides embodiments of a data transmission apparatus and a data transmission system.

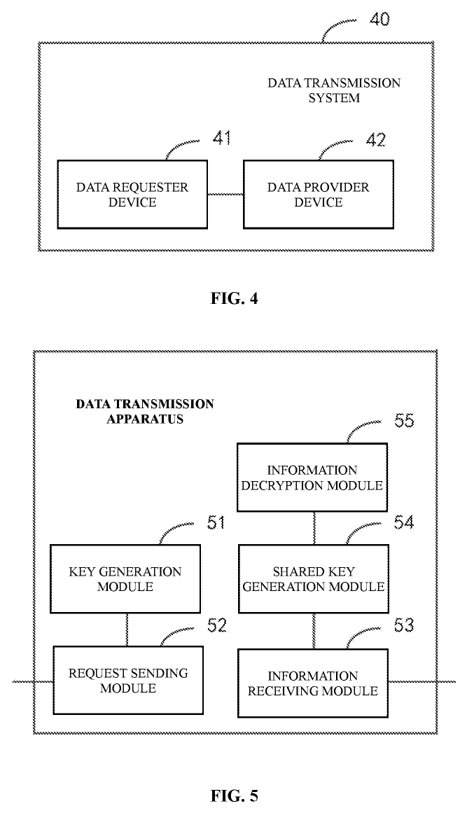

FIG. 4 is a block diagram of an embodiment of a data transmission system. In some embodiments, the system 40 comprises a data requester device 41 and a data provider device 42. The data requester device 41 generates an asymmetrical key pair comprising a first public key and a first private key and sends a data request carrying the first public key to the data provider device 42.

The data provider device 42 obtains an asymmetrical key pair comprising a second public key and a second private key and generates a shared key based on the second private key and the first public key using a preset key-agreement algorithm.

The data provider device 42 uses the shared key to encrypt target data to which the data request corresponds and sends a ciphertext obtained from encryption and the second public key to the data requester device 41.

The data requester device 41 generates a shared key based on the first private key and the second public key using the key-agreement algorithm and uses the shared key to decrypt the ciphertext to obtain the target data.

Here, the shared key generated based on the second private key and the first public key using the preset key-agreement algorithm is identical to the shared key generated based on the first private key and the second public key using the key-agreement algorithm.

In some embodiments, the data requester device 41 uses a private key in a requester certificate to sign the first public key to obtain first signature information and sends a data request carrying the first public key and the first signature information to a data provider device 42. The requester certificate is a certificate issued by a designated institution to the data requester device.

Before the data provider device 42 returns a ciphertext and a second public key to the data requester device 41, the data provider device 42 verifies the first signature information based on a public key in the requester certificate and the first public key and determines the verification is successful.

In some embodiments, the data provider device 42 uses a private key in a provider certificate to sign the second public key to obtain second signature information. When a ciphertext obtained from encryption and the second public key are sent to the data requester device 41, the data provider device 42 sends the second signature information to the data requester device 41, too; the provider certificate is a certificate issued by a designated institution to the data provider device 42.

Before the data requester device 41 decrypts a ciphertext, the data requester device 41 verifies the second signature information based on a public key in the provider certificate and the second public key and determines the verification is successful.

FIG. 5 is a block diagram of an embodiment of a data transmission apparatus. In some embodiments, the apparatus comprises: a key generation module 51, a request sending module 52, an information receiving module 53, a shared key generation module 54, and an information decryption module 55.

The key generation module 51 is configured to generate an asymmetrical key pair comprising a first public key and a first private key.

The request sending module 52 is configured to send a data request carrying the first public key to a server.

The information receiving module 53 is configured to receive a ciphertext and a second public key sent by the server, wherein the second public key is a public key in an asymmetrical key pair obtained by the server, the asymmetrical key pair obtained by the server further comprises a second private key, and the ciphertext is information obtained by encrypting a seed parameter for generating an offline payment code using a shared key; the shared key is a key generated based on the second private key and the first public key using a preset key-agreement algorithm.

The shared key generation module 54 is configured to generate a shared key based on the first private key and the second public key using the key-agreement algorithm.

The information decryption module 55 is configured to use the shared key to decrypt the ciphertext and obtain the seed parameter.

Here, the shared key generated based on the second private key and the first public key using the preset key-agreement algorithm is identical to the shared key generated based on the first private key and the second public key using the key-agreement algorithm.

In some embodiments, the request sending module 52 is configured to: use a private key in a client certificate to sign the first public key to obtain first signature information, wherein the client certificate is a certificate issued by a designated institution to the client; and send a data request carrying the first public key and the first signature information to a server so that the server uses a public key in the client certificate and the first public key to verify the first signature information, and sends the ciphertext and the second public key to the client if verification is successful.

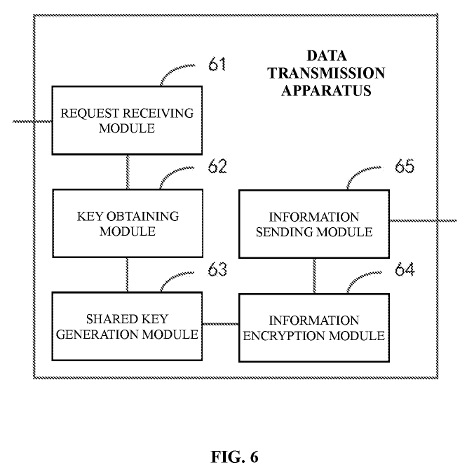

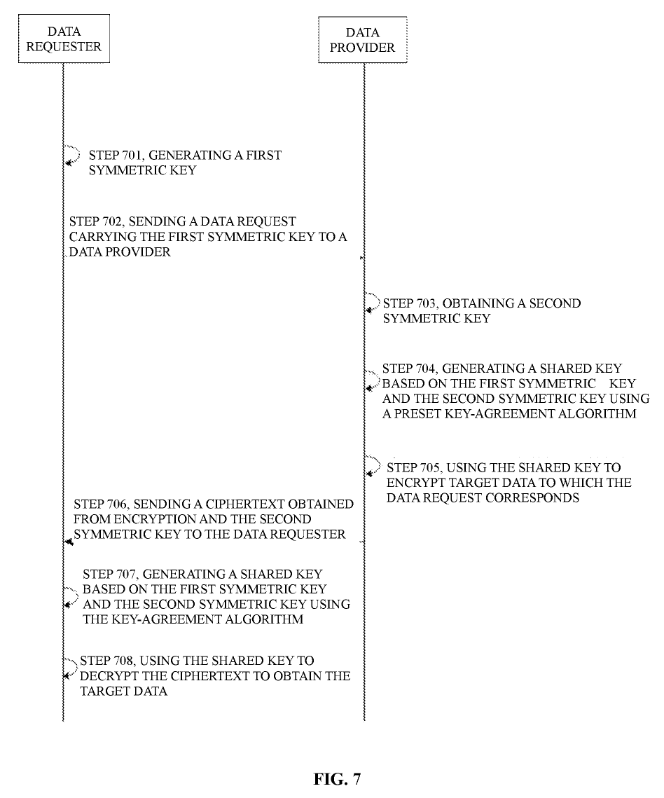

FIG. 6 is a block diagram of another embodiment of a data transmission apparatus. According to some embodiments, the apparatus comprises: a request receiving module 61, a key obtaining module 62, a shared key generation module 63, an information encryption module 64, and an information sending module 65.

Here, the request receiving module 61 is configured to receive a data request carrying a first public key and sent by a client, wherein the data request is for requesting a server to return a seed parameter for generating an offline payment code, the first public key is a public key in an asymmetrical key pair generated by the client, and the asymmetrical key pair generated by the client further comprises a first private key.

The key obtaining module 62 is configured to obtain an asymmetrical key pair comprising a second public key and a second private key.

The shared key generation module 63 is configured to generate a shared key based on the second private key and the first public key using a preset key-agreement algorithm.

The information encryption module 64 is configured to use the shared key to encrypt a seed parameter to which the data request corresponds.

The information sending module 65 is configured to send a ciphertext obtained from encryption and the second public key to the client so that the client generates a shared key based on the first private key and the second public key using the key-agreement algorithm and uses the shared key to decrypt the ciphertext to obtain the seed parameter.

Here, the shared key generated based on the second private key and the first public key using the preset key-agreement algorithm is identical to the shared key generated based on the first private key and the second public key using the key-agreement algorithm.

In some embodiments, the apparatus shown in FIG. 6 may further comprise a signature module configured to use a private key in a server certificate to sign the second public key to obtain second signature information, wherein the server certificate is a certificate issued by a designated institution to the server.

The information sending module 65 is further configured to send the second signature information to the client when sending a ciphertext obtained from encryption and the second public key to the client so that the client verifies the second signature information based on a public key in the server certificate and the second public key. After the verification is successful, the client decrypts the ciphertext.

Based on this, the specification further provides a wearable device. The wearable device comprises an SE chip, which is configured to: generate an asymmetrical key pair comprising a first public key and a first private key and send a data request carrying the first public key to a server; receive a ciphertext and a second public key sent by the server, wherein the second public key is a public key in an asymmetrical key pair obtained by the server, the asymmetrical key pair obtained by the server further comprises a second private key, and the ciphertext is information obtained by encrypting a seed parameter for generating an offline payment code using a shared key; the shared key is a key generated based on the second private key and the first public key using a preset key-agreement algorithm; and generate a shared key based on the first private key and the second public key using the key-agreement algorithm, and using the shared key to decrypt the ciphertext and obtain the seed parameter.

Here, the shared key generated based on the second private key and the first public key using the preset key-agreement algorithm is identical to the shared key generated based on the first private key and the second public key using the key-agreement algorithm.

In some embodiments, through configuration of an SE in a wearable device, generation of an asymmetrical key pair, generation of a shared key, storage of target data, and decryption of a ciphertext are conducted in the SE. Further, as the SE has an anti-cracking function, the SE may provide the target data with a very high security level.

In order to avoid the problems of information security and prolonged encryption and decryption in current technologies, the specification further provides an alternative data transmission method, as shown in FIG. 7. FIG. 7 is a flow chart of another embodiment of a data transmission method. The method may comprise the following step 701˜step 708:

In step 701, a data requester terminal generates a first symmetric key.

In step 702, the data requester terminal sends a data request carrying the first symmetric key to a data provider terminal.

In step 703, the data provider terminal obtains a second symmetric key, which is different from the first symmetric key.

In step 704, the data provider terminal generates a shared key based on the first symmetric key and the second symmetric key using a preset key-agreement algorithm.

In step 705, the data provider terminal uses the shared key to encrypt target data to which the data request corresponds.

In step 706, the data provider terminal sends a ciphertext obtained from encryption and the second symmetric key to the data requester terminal.

In step 707, the data requester terminal generates a shared key based on the first symmetric key and the second symmetric key using the key-agreement algorithm.

In step 708, the data requester terminal uses the shared key to decrypt the ciphertext to obtain the target data.

In some embodiments, a first symmetric key may be obtained through a data requester terminal, a data request carrying the first symmetric key is sent to a data provider terminal, a second symmetric key is obtained through a data provider terminal, a shared key is generated based on the first symmetric key and the second symmetric key using a preset key-agreement algorithm, then the shared key is used to encrypt target data to which the data request corresponds, and lastly a ciphertext obtained from encryption and the second symmetric key are transmitted to the data requester terminal, and the data requester terminal uses the same key-agreement algorithm to generate a shared key based on the first symmetric key and the second symmetric key. As a data provider terminal and a data requester terminal use an identical key-agreement algorithm, the shared key generated by the data provider terminal and that generated by the data requester terminal are identical, and the data requester terminal may decrypt the ciphertext through the generated shared key, thereby obtaining the target data. Given that the asymmetrical key algorithm uses a different random number during each calculation, a different asymmetrical key pair is generated during each calculation. Therefore, asymmetrical key pairs generated by different clients are different, too, avoiding the problem of a security risk for all client devices and server devices resulting from leakage of the key of a client device or a server device. Meanwhile as the shared key is different from the first symmetric key and the second symmetric key, even if a hacker has hijacked the symmetric key, the hacker will not know what key-agreement algorithm the terminals have used, so the hacker is unable to decrypt the ciphertext, thereby ensuring data security throughout the entire transmission process. Further, as the key for encryption of target data and the key for decryption of target data are identical, symmetric key encryption and decryption algorithms are used to encrypt and decrypt data to avoid long encryption and decryption times resulting from complex asymmetrical encryption and decryption algorithms, thereby improving encryption and decryption efficiency.

Here, the key generation algorithm generating a first symmetric key and the key generation algorithm generating a second symmetric key may be the same or different. As the symmetric key generated by the key generation algorithm is different each time, the second symmetric key is different from the first symmetric key.

After the data requester terminal obtains a first symmetric key, it may generate a data request carrying a first symmetric key based on the first symmetric key. Here, the data request is used to request target data. After the data request is generated, it may be sent to a data provider terminal.

In an example, the data requester terminal may use a data request to directly carry a first symmetric key, thereby raising the speed of sending a data request.

In another example, sending a data request carrying the first symmetric key to a data provider terminal comprises: the data requester terminal using a private key in a requester certificate to sign the first symmetric key to obtain first signature information. The requester certificate is a certificate issued by a designated institution to the data requester terminal.

The data requester terminal sends a data request carrying the first symmetric key and the first signature information to a data provider terminal.

Here, the designated institution may be an institution that can issue certificates. A certificate issued by the designated institution to a data requester terminal comprises at least a private key and a public key.

After a data provider terminal receives a data request, the data provider terminal may verify the first signature information based on a public key in the requester certificate and the first symmetric key. After the verification is successful, the data provider terminal will execute the operation of returning a ciphertext and a second symmetric key to the data requester terminal.

In some embodiments, signing a first symmetric key and successfully verifying the first signature information may guarantee the first symmetric key is not tampered with, and meanwhile a requester certificate ensures the data requester terminal is a safe terminal authenticated by an authoritative institution, thereby ensuring the security of the negotiation process of a shared key.

After a data provider terminal receives a data request, the data provider terminal may obtain a second symmetric key. After the data provider terminal obtains the second symmetric key, the data provider terminal may generate a shared key based on the first symmetric key and the second symmetric key using a preset key-agreement algorithm.

Here, a key-agreement algorithm, also known as a key exchange algorithm, may be an ECDH algorithm, for example, wherein ECDH is a DH (Diffie-Hellman) key exchange algorithm based on ECC (Elliptic Curve Cryptosystems). Therefore, the two parties may negotiate a common key without sharing any secret information.

A data provider terminal may use the shared key to encrypt target data to which the data request corresponds and send a ciphertext obtained from encryption and the second symmetric key to the data requester terminal.

In an example, a data provider terminal may directly send a second symmetric key to a data requester terminal to improve sending efficiency.

In another example, the data provider terminal uses a private key in a provider certificate to sign the second symmetric key to obtain second signature information. The provider certificate is a certificate issued by a designated institution to the data provider terminal.

When the data provider terminal sends a ciphertext obtained from encryption and the second symmetric key to the data requester terminal, the data provider terminal will further send the second signature information to the data requester terminal.

Here, the designated institution may be an institution that can issue certificates. A certificate issued by the designated institution to a data provider terminal comprises at least a private key and a public key. In other words, a provider certificate comprises a private key and a public key.

The data requester terminal verifies the second signature information based on a public key in the provider certificate and the second symmetric key. After the verification is successful, the data requester terminal executes the step of decrypting a ciphertext.

In some embodiments, signing a second symmetric key and successfully verifying second signature information may guarantee the second symmetric key is not tampered with, and meanwhile a provider certificate ensures the data provider terminal is a safe terminal authenticated by an authoritative institution, thereby ensuring the security of the negotiation process of a shared key.

Corresponding to the embodiment of a data transmission method provided by the specification, the specification further provides an embodiment of a data transmission system.

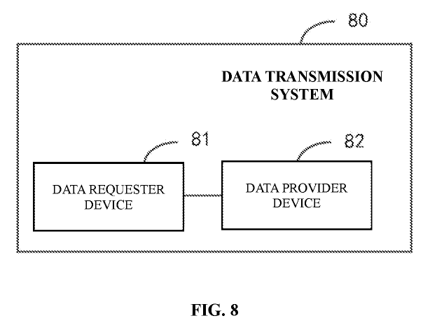

FIG. 8 is a block diagram of another embodiment of a data transmission system. According to some embodiments, the system 80 comprises a data requester device 81 and a data provider device 82.

The data requester device 81 generates a first symmetric key and sends a data request carrying the first symmetric key to the data provider device 82.

The data provider device 82 obtains a second symmetric key and generates a shared key based on the first symmetric key and the second symmetric key using a preset key-agreement algorithm, the second symmetric key being different from the first symmetric key.

The data provider device 82 uses the shared key to encrypt target data to which the data request corresponds and sends a ciphertext obtained from encryption and the second symmetric key to the data requester device 81.

The data requester device 81 generates a shared key based on the first symmetric key and the second symmetric key using the key-agreement algorithm and uses the shared key to decrypt the ciphertext to obtain the target data.

The processes of achieving the functions and effects of every module in the foregoing apparatus are detailed in the achieving processes of corresponding steps in the foregoing method, so no unnecessary details will be repeated.

The apparatus embodiment basically corresponds to the method embodiment, so for relevant parts of the apparatus, please refer to the corresponding parts of the method embodiment. The apparatus embodiment described above is exemplary only, its units described as separate components may or may not be physically separate, and the components displayed as units may or may not be physical units, i.e., they may be located in the same place or distributed on a plurality of network units. Some or all of the modules may be selected according to the actual need to achieve the objectives of the solution disclosed herein. Those of ordinary skill in the art can understand and implement it without creative effort.

When the functions disclosed herein are implemented in the form of software functional units and sold or used as independent products, they can be stored in a processor executable non-volatile computer readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

After considering the Description and practicing the disclosed subject matter, those skilled in the art may easily think of other embodiments. The specification is intended to cover any modification, use, or adaptive change of the disclosed subject matter. These modifications, uses, or adaptive changes follow the general principle of the specification and include the common general knowledge or conventional technical means in the technical field not applied for by the specification. The Description and embodiments are exemplary only.

It should be understood that the specification is not limited to the precise structure described above and shown in the accompanying drawings, and various modifications and changes may be made without departing from its scope.

1. A data-transmission method, comprising:
generating, by a computing device, a first asymmetrical key pair comprising a first public key and a first private key;
sending, by the computing device, a data request comprising the first public key to a server;
receiving, by the computing device from the server, a ciphertext comprising encrypted data and a second public key, wherein the second public key is associated with a second asymmetrical key pair that further comprises a second private key;
generating, by the computing device, a shared key based on the first private key and the second public key using a key-agreement algorithm; and
decrypting, by the computing device, the ciphertext using the shared key.

2. The method of claim 1, wherein the data comprises:
a seed parameter for generating an offline payment code.

3. The method of claim 1, wherein:
the shared key is identical to a key generated based on the second private key and the first public key using the key-agreement algorithm.

4. The method of claim 1, wherein the sending a data request comprising the first public key to a server comprises:
obtaining first signature information by signing the first public key using a private key in a client certificate; and
including the first signature information in the data request.

5. The method of claim 1, wherein:
the key-agreement algorithm is a Diffie-Hellman key exchange algorithm based on elliptic curve cryptosystems.

6. The method of claim 1, wherein:
the computing device is a wearable device.

7. The method of claim 6, wherein:
the wearable device comprises a smart bracelet.

8. A data-transmission system, comprising a processor and a non-transitory computer-readable storage medium storing instructions executable by the processor to cause the system to perform operations comprising:
generating a first asymmetrical key pair comprising a first public key and a first private key;
sending a data request comprising the first public key to a server;
receiving a ciphertext comprising encrypted data and a second public key, wherein the second public key is associated with a second asymmetrical key pair that further comprises a second private key;
generating a shared key based on the first private key and the second public key using a key-agreement algorithm; and
decrypting the ciphertext using the shared key.

9. The system of claim 8, wherein the data comprises:
a seed parameter for generating an offline payment code.

10. The system of claim 8, wherein:
the shared key is identical to a key generated based on the second private key and the first public key using the key-agreement algorithm.

11. The system of claim 8, wherein the sending a data request comprising the first public key to a server comprises:
obtaining first signature information by signing the first public key using a private key in a client certificate; and
including the first signature information in the data request.

12. The system of claim 8, wherein:
the key-agreement algorithm is a Diffie-Hellman key exchange algorithm based on elliptic curve cryptosystems.

13. The system of claim 8, wherein:
the system comprises a wearable device.

14. The system of claim 13, wherein:
the wearable device comprises a smart bracelet.

15. A non-transitory computer-readable storage medium for data transmission, configured with instructions executable by one or more processors to cause the one or more processors to perform operations comprising:
generating a first asymmetrical key pair comprising a first public key and a first private key;
sending a data request comprising the first public key to a server;
receiving a ciphertext comprising encrypted data and a second public key, wherein the second public key is associated with a second asymmetrical key pair that further comprises a second private key;
generating a shared key based on the first private key and the second public key using a key-agreement algorithm; and
decrypting the ciphertext using the shared key.

16. The medium of claim 15, wherein the data comprises:
a seed parameter for generating an offline payment code.

17. The medium of claim 15, wherein:
the shared key is identical to a key generated based on the second private key and the first public key using the key-agreement algorithm.

18. The medium of claim 15, wherein the sending a data request comprising the first public key to a server comprises:
obtaining first signature information by signing the first public key using a private key in a client certificate; and
including the first signature information in the data request.

19. The medium of claim 15, wherein:
the key-agreement algorithm is a Diffie-Hellman key exchange algorithm based on elliptic curve cryptosystems.

20. The medium of claim 15, wherein:
the non-transitory computer-readable storage medium is embedded in a wearable device.
